(19) United States
(12) Patent Application Publication
(10) Pub. No.: US 2018/0354111 A1
(43) Pub. Date: Dec. 13, 2018

(54) Shower cartridge puller

(71) Applicant: Evan Hamilton Getchell, Scotts Dale, AZ (US)

(72) Inventor: Evan Hamilton Getchell, Scotts Dale, AZ (US)

(21) Appl. No.: 15/731,430

(22) Filed: Jun. 9, 2017

(51) Int. Cl. B25B 27/06; B25B 27/24; B23P 19/04

(52) U.S. Cl. CPC B25B 27/062; B23P 19/00; B23P 19/04; B25B 27/24

(57) ABSTRACT

A system for removal of Moen cartridges or cores and sleeves from plumbing valve bodies is facilitated with a tool having concave, cylindrical billed jaws on a vise-grip pair of pliers and a specially built extraction tool on the screw end of the vise-grip. The outer shape of the billed jaws matches the outer diameter of the cartridge's core. The tool's bills lock on the inner core of the cartridge. Ideally the inner core and outer sleeve will both be extracted with the tool's bills. When conditions are not ideal due to hardened or broken o-rings and corrosion, rotating the tool and cartridge are required to free them from the valve body. The Pasco stem and cartridge puller attached to the screw end of the vise-grips is used to extract the outer sleeve of the cartridge after the inner core has been removed.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

This invention relates to the cartridges found in water faucets and showers, most of which are manufactured by the Moen Company, other companies also applying the now expired patent. The cartridge is generally single-handled and works by mixing hot and cold water through the up and down, right and left, turning of the single-handle. (The water then flows from either the shower head or faucet according to how the handle is adjusted.) After the passage of considerable time, the cartridge eventually “wears out” in the sense of becoming corroded and non-functional, due to the corrosive impact of impurities in the water. This invention is intended to remove the defective cartridge without harming the plumbing structure which undergirds it.

### Description of Prior Art

The Moen Corporation makes a tool for cartridge removal which works part of the time but is restricted to core-pulling: the sleeve is often left behind in the wall or the faucet. Also, the Moen tool requires the use of a wrench for torsion. Rucker, U.S. Pat. No. 6,929,024 discloses a secondary tool to be used as an addition to the Moen tool. It is superior to the Moen tool but still has major disadvantages. That is, Rucker teaches a large custom-design tap which is intended to be attached to the end of the Moen tool and is used to cut threads into the wall of the sleeve. The tapping process is unfamiliar to most do-it-yourselfers and is difficult to execute. The tapping process also has the disadvantage of creating metal shreds which could easily pass through holes in the sides of the sleeve and thereby wedge between the sleeve and the housing. The metal shreds are likely to cause damage to the wall of the housing during the core-pulling process. Also a significant disadvantage of Rucker is the fact that frozen sleeves generally require a twisting motion to break up the rigid sediment between the sleeve and the wall of the housing. Rucker does not provide that twisting motion. The disadvantages of Rucker are chiefly that it is expensive, requires extensive mechanical knowledge and that it is subject to failure.

A tool for pulling both core and sleeve is taught by Hseu, U.S. Pat. No. 5,119,556. Hseu is better than Rucker as it uses a cylinder which engages by sliding on a threaded rod. A flat handle is threaded onto the rod above the cylinder. On the rod below the cylinder is a thin, oval washer and below the washer is a stop, which is threaded on near the bottom end of the rod in order to retain the washer. Below the stop is a thread which engages the thread in the core. The tool is attached to the core and the cylinder is placed against the rim of the housing. The threaded handle is advanced along the rod and presses on the cylinder in order to create a pulling force on the core. To operate the tool, the cylinder must be held against the rim of the housing, after which the handle must be turned and the threaded rod must be held to prevent it from turning. The operation of the Hseu tool is awkward and requires significant amounts of dexterity.

The tool disclosed by Seminario, U.S. Pat. No. 3,952,394 is a better tool for pulling a Moen cartridge but it also suffers from a number of problems. Seminario shows a core-pulling device which presents difficulties in actual usage. Seminario teaches that the core should be removed by “a relative motion of the threaded rod and the bar” of the tool. This is difficult to perform because a cylinder must be held in contact with the rim of the housing, while the threaded rod must be prevented from turning while the bar is rotated. This awkward maneuver is similar to the Hseu tool—and thus shares its disadvantages.

Finally, a cartridge puller is disclosed by English, U.S. Pat. No. 7,987,571, which corrects some of the problems of both Hseu and Seminario. English teaches a cartridge puller consisting of a core puller, a sleeve puller and an interchangeable handle. The sleeve puller has an external hex on its body for the attachment of a wrench to apply substantial, sharp twisting forces to the jammed sleeve, frozen by corrosion and sediment. The necessity of a wrench makes it inferior to the ease of my new invention which requires no wrench, needing only itself to perform both core pulling and sleeve pulling.

The present invention requires NO wrench and it may be used by inexperienced users of no particular strength. This new invention is inexpensive and conceptually simple; thus, it is ideal for weekend handymen or other amateur do it yourselfers. It is also well-adapted for professional plumbers.

### BRIEF DESCRIPTION OF THE SEVERAL VIEWS OF THE DRAWINGS

FIG. 1 shows the invention With its various parts; 10 being the handle, 12 the grip, 15 the release, 16 the screw, 18 the Pasco stem puller, 20 is the case, 22 the nipple, 23 the body of the plumbing fixture and 24 the pre-existing hole which is manufactured in the body of the plumbing fixture. FIG. 2 illustrates the opposite end of the invention, with 28 being the billed end of the vise-grip pliers, 20 is the cartridge, 30 is the valve body, while 10 is the handle, 12 is the grip and 26 the spring. FIG. 3 shows 10 the handle, 12 the grip, 26 the spring, 28 the billed mouth of the pliers, 30 is the body of the plumbing fixture, 32 the inner cartridge sleeve, 34 the outer sleeve and 35 the core. FIG. 4 shows 10 the handle, 12 the grip, 15 the release, 16 the screw, 18 the Pasco stem puller, 22 the nipple, 23 the core, 26 the spring and 32 the link of the vise-grip pliers. FIG. 5 shows the complete invention with all its parts, which were previously described.

### SUMMARY OF THE INVENTION

The present invention is a tool which is capable of removing and replacing a shower mixing valve known as a cartridge, especially those recognized by the generic name of Moen. This can be done easily and quickly by a worker of average skill and dexterity. It does not require a professional plumber, which is the chief drawback of most prior inventions dealing with removal and replacement of shower and faucet cartridges. My invention provides a more sure control to replace both the core and the sleeve, without the use of a wrench, tap or potentially awkward additional tool. My invention is complete in one unit, everything is contained in a single tool, without the drawbacks and complexity of other conventionally available tools and methods. The one-handed tool I have invented consists of a vise-grip type pliers, made for instance by Milwaukee Manufacturing. The pliers come with flat plates as bills on the mouth of the pliers. I drilled at the billed end of the pliers, in between the adjoining plates with a 7/16″ drill to make the circular, concave bills that can grasp the core of the plumbing fixture known as the cartridge. To the tension adjustment/screw end of the vise-grip pliers, I threaded the shaft of an Ace stem and cartridge puller by Pasco, so it becomes one piece with the pliers. This facilitates the tension adjustment of the pliers and utilizes the nipple feature on the opposite side of the Pasco stem and cartridge puller to grasp the outer sleeve of the plumbing cartridge. When retrieving the core from the cartridge, the first thing that my invention does is to grasp the protruding core of the cartridge with the concave feature of the bills of the vise-grip pliers. The vise-grip pliers are then turned from side to side while pulling, which will remove both the core and the sleeve of the cartridge out of the valve body under favorable conditions. Often, however, due to corrosion and broken o-rings, the sleeve portion of the cartridge may remain lodged in the valve body, at which time the opposite screw end of my invention is used. The threaded Pasco stem puller with the nipple attached to the screw end of the pliers must be employed to remove the recalcitrant sleeve. That is, the cartridge sleeve pulling feature at the other end of the threaded tension adjustment shaft has a nipple at the end which fits into a hole manufactured in the sleeve. Then the sleeve can be removed by a person of average skill and dexterity. Replacement of a new cartridge assembly is easily facilitated with positive control of the cartridge securely held by the concave bill section of the pliers which is then pushed into position within the plumbing housing.

### Preferred Embodiment of the Invention

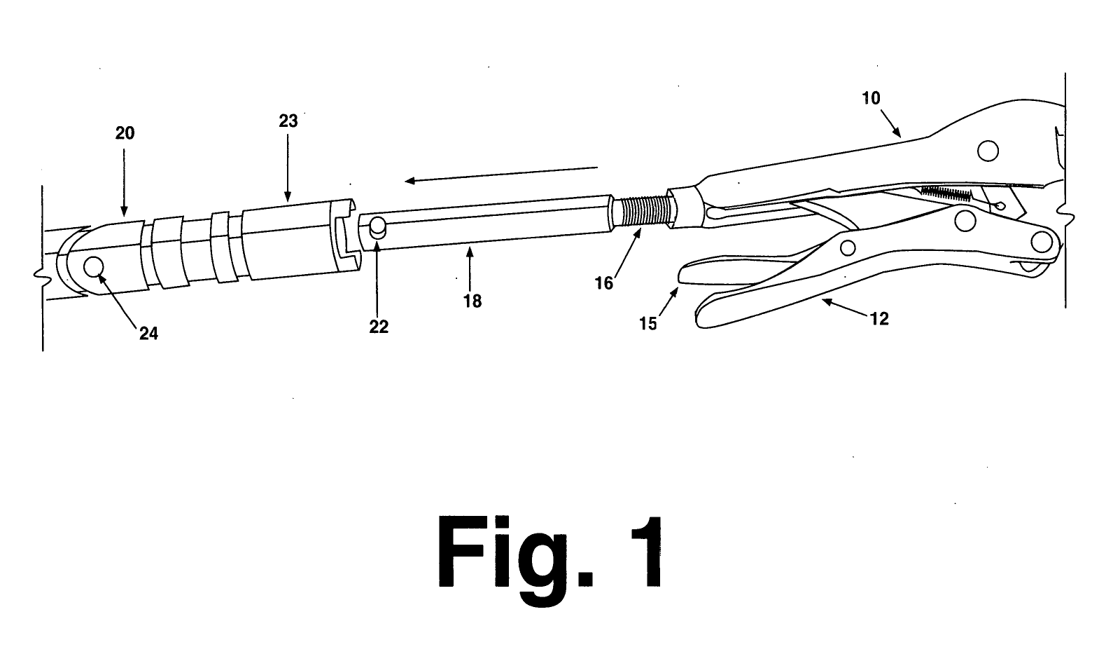

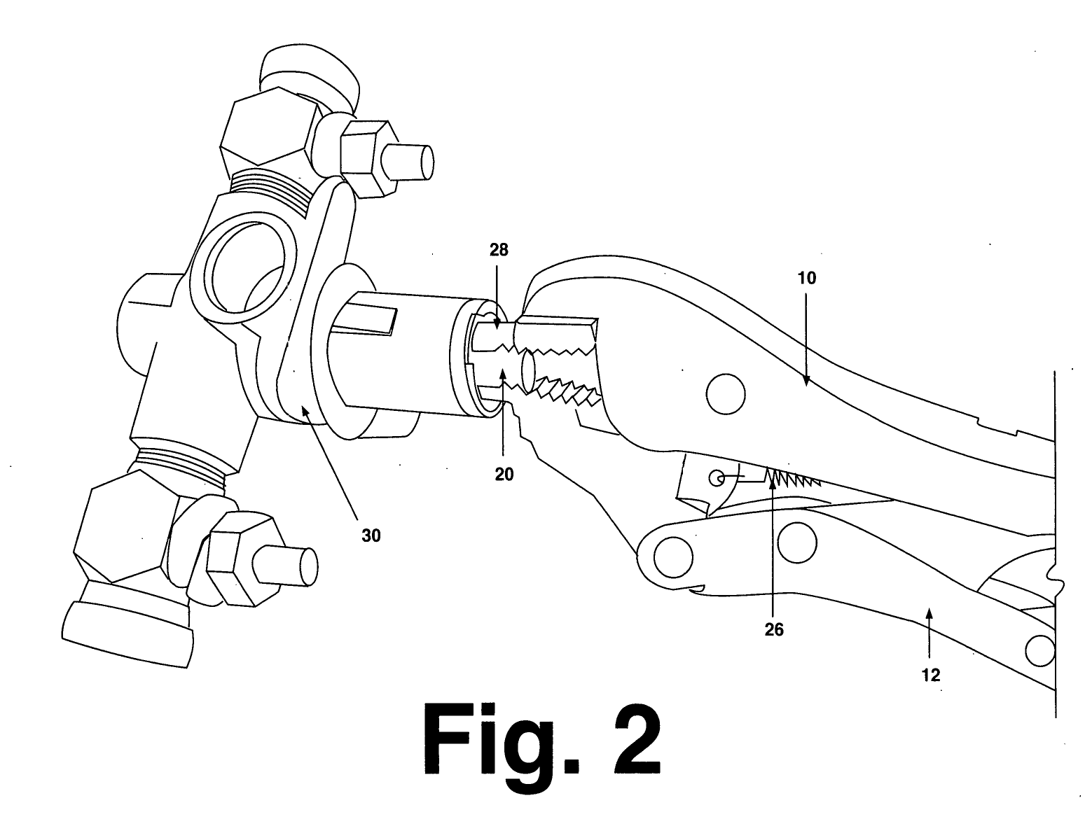

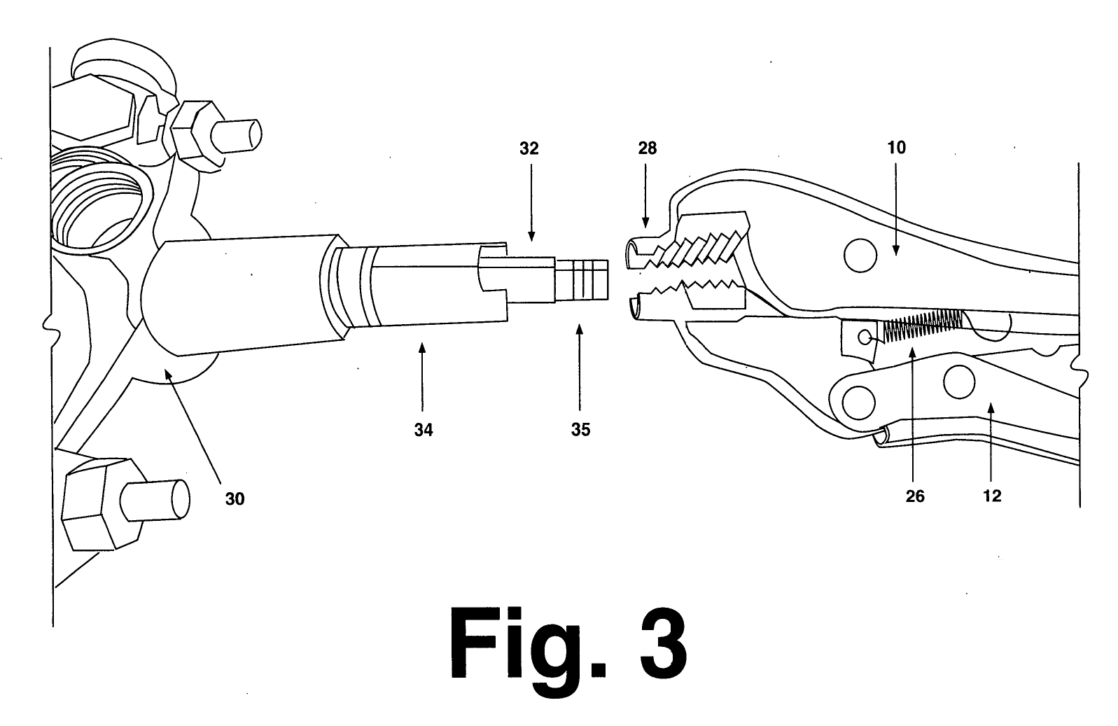

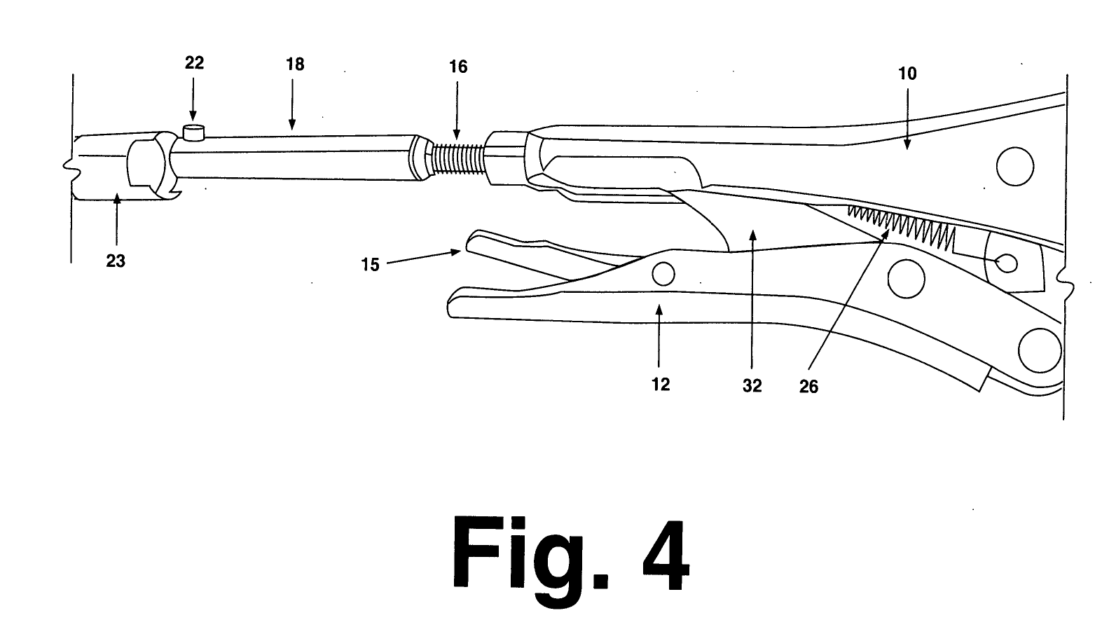

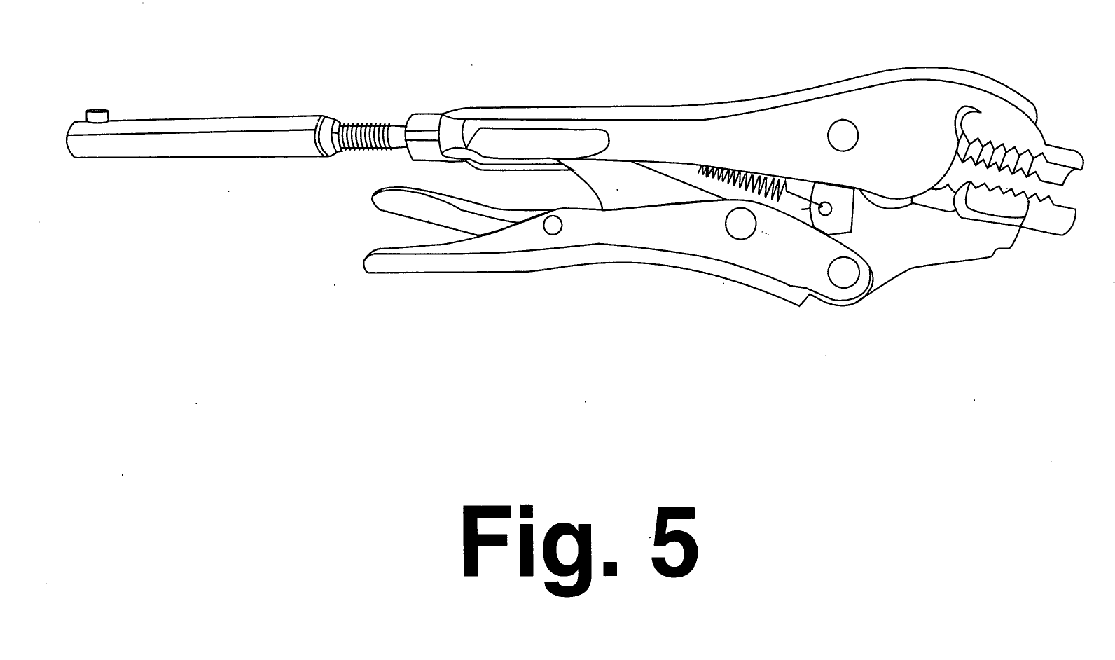

FIG. 1 illustrates my invention by way of the screw end with the Pasco stem puller threaded onto the screw of the vise-grip pliers and ready to be inserted into a plumbing fixture. Following the numbers: 10 is the handle of the vise-grip pliers, 12 is the grip and 15 is the release, all of which are necessary at some point in repairing a shower cartridge. The invented portion of the vise-grip pliers consists of 16 which is the screw and 18 is the Pasco stem puller which has been threaded onto the screw of the pliers. 22 is the nipple which is a part of the Pasco stem puller while 24 is the hole which is manufactured into the plumbing fixture and which receives the nipple (22) for easy removal. Notice the force arrow which shows the direction of insertion into the plumbing fixture. 23 is the body of the plumbing fixture which holds the sleeve which the nipple 22 removes by fitting into the hole, which is 24. FIG. 2 illustrates the opposite end of my invention which shows 28 the billed ends of the vise-grip pliers which are applied to 20, which is the cartridge and more exactly the protruding core of the cartridge. 30 shows the valve body as it would appear in a standard plumbing configuration. The point of FIG. 2 is that the bills on the end of the pliers fit neatly over the core of the cartridge and in most instances, will simply pull it out without difficulty. In the event of a corroded fixture or broken o-rings, it is necessary to twist the pliers while the bills are holding the core, back and forth with varying degrees of vigor, to dislodge the core. FIG. 3 shows a more exact picture of the billed endings, which are 28 and about to grip the core, which is 35, protruding from 32, which is the inner cartridge sleeve. Again, if the core is in good condition, gripping it with the billed ends essentially completes the operation, as the core is easily dislodged by means of the bills. If, however, there is corrosion from long use or a broken o-ring, it ,is necessary to twist the pliers back and forth for a short time, in order to dislodge the core. FIG. 3, again shows the beauty and simplicity of my invention as apart from the drilled bills, which I drilled with a 7/16^{th} inch drill and the threaded Pasco stem puller, this is a standard vise-grip pliers. That is, 10 is the handle, 26 is the standard spring and 12 is the grip. FIG. 4 illustrates the screw end of the vise-grip pliers having been fitted with the Pasco stem puller which was attached to the screw by means of the tap and die set known as “a quarter 20.” The nipple 22 is about to be fitted into the body of the cartridge 23 in order that the core may be extracted by the Pasco stem puller 18. Again, the simplicity of my invention is such that the other numbers reflect the standard parts of a vise-grip pliers. That is, 16 is the screw, 10 is the handle, 26 is the spring, 32 is the link of the vise-grip pliers, 12 is the grip and 15 is the release.

I claim:

1. A system for pulling shower and faucet valve cartridge cores and sleeves from plumbing housings, said system consisting of a single tool which is a modified vise-grip pliers with billed ends at the mouth:
the billed ends are rendered concave by drilling with a 7/16 inch drill and thereby producing the desired said concave bills. The screw end of the vise-grip pliers are modified by threading a Pasco stem and cartridge puller onto the screw. The Pasco stem and cartridge puller comes with a nipple at the far end which engages the hole in the sleeves of plumbing fixtures and thereby removes the sleeve. The said billed ends are designed to engage the core of the valve cartridge and pull it out by compressing the pliers in a standard fashion. The said Pasco stem and cartridge puller which is threaded to the screw end of the pliers by means of a tap and die set known as “a quarter 20” pulls out the sleeve by engaging the plumbing fixture at the hole which is manufactured in the sleeve. The said Pasco stem puller, threaded to the screw of the vise-grip pliers, is used to retrieve the sleeve of the valve set by means of the nipple which fits into the hole manufactured into the sleeve. The vise-grip pliers are well suited to twisting back and forth in order to remove both the core and the sleeve.
